(19) United States
(12) Patent Application Publication
(10) Pub. No.: US 2006/0275550 A1
(43) Pub. Date: Dec. 7, 2006

(54) Tire dressing method and assembly

(76) Inventors: Daniel Mark DeBoer, Paw Paw, MI (US); David Egbert Zuiderveen, Kalamazoo, MI (US)

Correspondence Address: JOSEPH KOORKIN ANDONIAN, 5137 RIDGEBROOK DRIVE, PORTAGE, MI, 49002, US

(21) Appl. No.: 11/437,931

(22) Filed: May 19, 2006

Related U.S. Application Data
(60) Provisional application No. 60/683,026, filed on May 20, 2005.

(51) Int. Cl. B05D 3/12

(52) U.S. Cl. 427/371

(57) ABSTRACT

An apparatus and method are disclosed for applying a substance to a predetermined area of a work piece such as a sidewall of a vehicle tire at a specific instance in time. One embodiment of the invention comprises at least one sensor disposed at a fixed location for detecting the presence of the work piece at a specified location. A spray assembly is also provided proximate the fixed location and adapted to spray a substance on the work piece when the work piece is at the specified location. A micro-computer or other processor is used to detect the signal from the at least one sensor, and to actuate the spray assembly so that the substance is sprayed upon the work piece. The method for operating the invention comprises detecting the presence of the work piece at the specified location along a path traversed by the work piece and causing the spray assembly proximate the location to direct the substance upon the work piece only while the work piece is at that location.

### BACKGROUND OF THE INVENTION

1. Field of the Invention

This invention relates to applicators, and particularly to a unique application and method for applying a tire dressing to a vehicle tire without touching the tire.

2. Brief Description of the Related Art

The car wash industry offers a diverse range of automated car-washing systems or assemblies. These range from simple high to moderate pressure spraying machines to more complex systems using rotating brushes, agitators and buffers, as well as a combination of these systems. For many years patrons have applied a tire dressing to the vehicles tires to enhance the tire sheen. The automated car wash industry noticed this trend and began to offer similar services to patrons. For a specified fee the customer could receive the tire dressing on his or her vehicle's tires. This was often done manually by a car wash employee using a spray bottle applicator or a saturated rag or sponge. This application was often performed contemporaneously while the car was being towel dried by other car wash employees. The manual application of tire dressing presents a number of significant disadvantages, including possible injury to employees, inconsistency in application, as well as cost due to use of labor.

In recent history there have been attempts to automate the application of tire dressings. One such attempt is referred to herein as the “pad applicator.” The pad applicator is a device employing pads or brushes to apply the dressing fluid to the surface of the tire. Disadvantages associated with such devices include the need to contact the surface of the vehicle's tires. The contact induces wear and tear, misalignment as well as a host of other problems that lead to inconsistent applications, maintenance, and cost due to wasted tire dressing. Moreover, pad applicators are not desirable for use in “touchless” washes where the intention is not to touch the surface of the vehicle at all to remove soil and polish the appearance. Some patrons prefer touchless systems to prevent scratching or other damage to the vehicle. Another disadvantage of touch applicators is the size. Many of these units must extend to many feet adjacent the path of the vehicle so as to adequately cover the tire outer surface. Because tires come in different sizes with different profiles, depending upon the specific instance, the applicator may not apply enough or too much dressing, resulting in waste or at the very least poor results. In short, not very car wash using the fixed brush applicator is suitable arranged to work well on all vehicles.

In addition to the fixed pad or brush applicator described briefly above, other car washes have attempted to automate the application of fire dressing using spray systems. The location of the spray head or nozzle along the wash path of the vehicle was fixed. Timing systems were developed to control the application of the dressing as the car was aside the nozzle. Often the timing mechanisms were asynchronous with the actual location of the vehicle tire, resulting in the tire dressing missing the tires all together. As one may expect, patrons were unhappy about the additional cost of the service without receiving the benefit.

The instant invention ovens all of the foregoing problems and disadvantages of the prior methods and devices.

### SUMMARY OF THE INVENTION

An apparatus is provided for applying a dressing to a work piece, and particularly to an apparatus and method for applying a liquid dressing to a sidewall of a vehicle tire as the vehicle passes through an automated washing facility.

According to one form of the invention, the apparatus for applying the dressing to the sidewall of the vehicle tire includes a housing containing a plurality of spray nozzles spaced at predetermined intervals from one another. Operably coupled to the spray nozzles is a spray controller assembly for controlling when one or more of the respective nozzles are to be activated and apply the desired dressing. The spray controller assembly in turn is operably coupled to a switch assembly disposed along the floor of the washing facility to indicate with precision the location of the vehicles tires at any given moment.

According to another form of the invention, the housing containing the plurality of spray nozzle assemblies is supported a predetermined distance above a reference plane, such as the floor of the washing facility, by a plurality of stanchions or posts. It is anticipated that the position of the housing may be adjusted in three axes, each orthogonal to the others. This permits precision positioning and adjustment of the housing upon installation.

According to another form of the invention, a method is provided for applying a tire dressing to a surface of a tire with repetitive precision. The method includes detecting the position of the vehicle tire by at least one sensor adjacent a surface of the tire. The sensor detecting the position produces a signal received by a spray controller assembly, which in turn activates a respective assigned spray assembly to spray a predetermined amount of tire dressing material to the tire surface.

According to another form of the invention, a plurality of sensors arranged in an array may be positioned along or adjacent the path of the vehicle. Each sensor in the array is operably coupled trough a spray controller assembly to a respective spray nozzle assembly. As each sensor is activated, the spray controller assembly in turn activates a respective spray nozzle for spraying the dressing at the desired location. As the vehicle moves along the path, a different portion of the tire surface receives the tire dressing to provide the appropriate result.

The advantages offered by the different forms of the invention include determining with relative precision the location of the vehicle along the path of the washing facility to control when the tire dressing should be applied. Another advantage is that the system and method ensures the probability that a majority of the tire dressing will be applied to the vehicle tire rather than before or after the vehicle passes the application station. Another advantage of the invention is that the apparatus and method does not contact the vehicle and is truly a touchless applicator. Because no contact occurs between the applicator and the vehicle, errors in timing are substantially reduced, and alignment of the applicator is maintained resulting is less maintenance.

These and other advantages of the different forms of the invention can be appreciated and understood by reference to the following description, and particularly when considered in light of the accompanying drawing figures.

### BRIEF DESCRIPTION OF THE DRAWING FIGURES

FIG. 1 is a schematic diagram of one embodiment of an apparatus comprising the invention; and

FIG. 2 is a schematic illustrating greater detail of a portion of the invention shown in FIG. 1.

### DETAILED DESCRIPTION OF ONE EMBODIMENT

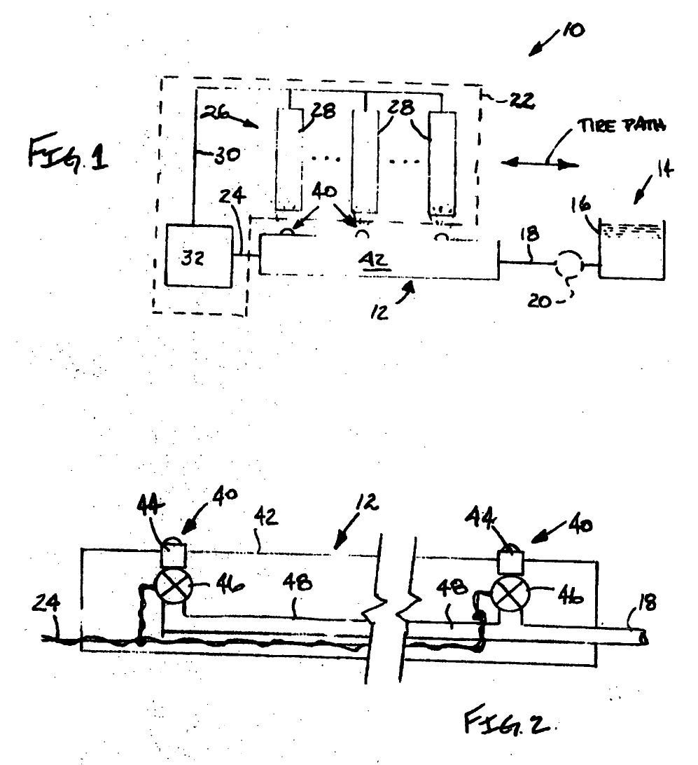

The reader is directed to drawing FIGS. 1 and 2 in connection with the following description for a better understanding of the nature of the invention. Although the invention is described herein with some degree of specificity, this description is not provided for the purposes of limiting the size, orientation, or limitation of any aspect of the invention. It is the intention of dais description to provide the reader with sufficient information to fully understand the rudimentary structure and function of the invention in just one operating environment. Unless specifically stated as a limiting factor in this description, size, dimensions, spacing or other metrics are not to be considered to limit the scope of the invention.

Referring to the drawing figures, one embodiment of the invention is an application assembly 10 including at least one spray assembly 12 disposed on each side of a vehicle path in a vehicle wash facility. Each spray assembly 12 is preferably positioned adjacent the path of the vehicle to easily apply the liquid dressing to the vehicle as it passes. A number of mounting systems may be employed for fixing the location of each spray assembly 12, but in a preferred embodiment what ever structure is adopted, one of the desired functions is to provide adjustment along any one or more of three orthogonal axes. Each spray assembly 12 in turn is connected to a source 14 of liquid dressing such as a reservoir, barrel or drum 16. Appropriate plumbing such as a hose 18 connects each spray assembly 12 with the drum 16. If desired, gravity feed, or assisted feed by way of a pump assembly 20, may be employed to pass the liquid to each spray assembly 12. Each spray assembly 12 is also operably connected to a spray controller assembly generally identified by reference numeral 22 through control lines 24. The spray controller assembly 22 may also be operably connected to the pump assembly 20 as will become apparent below.

The spray controller assembly 22 in turn comprises of at least one, and preferably an array 26 of sensors 28 positioned along the path of the vehicle. In a preferred embodiment, the sensors 28 may be positioned such that at least one vehicle tire rolls over each sensor to produce an output. In another alternative other sensors may be used such as optical beams or other devices to show the position of the vehicle tire. In the actual application, the type of sensor is not critical, so long as it produces an output when the vehicle tire is in the desired position. In the preferred embodiment shown, each sensor 28 comprises a pressure sensor detecting the weight of the vehicle. Each sensor is operably coupled through a transmission line 30 to a processor 32 such as a programmable logic control (PLC) or similar micro-computer such that upon the receipt of an output from a respective one of the sensors 28, the processor 32 in turn sends a signal to a respective one of the spray assemblies 12 and cause the dressing to be applied at the appropriate location. As seen in FIG. 1, an array 26 of four sensors 28 are spaced equidistantly from each other along a line corresponding to a path of at least one of the tires generally identified by reference numeral 34 such that as each sensor 28 is activated, the processor 32 produces an output over line 24 to activate each spray assembly 12.

Each spray assembly 12 is preferably comprised of at least one, and preferably an array of spray heads 40 fixed in spaced relationship to one another in a housing 42. Each pray head 40 includes a nozzle 44 directed outwardly from the housing 42 in a direction to spray a liquid onto a predetermined zone intended to cover a given area of the vehicle tire. Each spray head is also connected to a solenoid 46 intended to control when the respective spray ad applies the liquid dressing. Each solenoid 46 is operably coupled to the processor 32 via line 24. The coupling may be accomplished in a number of different ways so the processor can control the solenoids in concert or individually. For example, it is anticipated that the collection of solenoids 46 within a given housing 42 could be coupled to an addressable circuit board. The circuit board would then in turn be connected to the processor 32. In another embodiment, each solenoid may be connected via a dedicated hard wire directly to a port within the processor 32. Either way, a number of circuit arrangements may be adopted to individually control when each solenoid within the housing 42 is actuated. Each solenoid 46 also interconnects each spray head 40 to a manifold 48 which in turn is connected to the fluid line 18 described earlier. With the solenoid 46 placed close to each spray head 40 in this manner, timing of the application of the fluid provided to the tire by the spray head 40 is substantially instantaneous.

Employing the invention as described above, the method of applying a liquid to a given area of a vehicle may be controlled with a high degree of specificity and accuracy. The spray heads 40 mounted within housing 42 are arranged in a configuration matching the preferred location of the receiving surface at a given instant in time. In this embodiment the housing 42 is linear so that as the tire rolls past, a different portion of the tire becomes aligned or within the range of a given spray head 40. As mentioned above, the actual positioned of the housing 42 along a substrate may be accomplished in a number ways. One possible structure may include one or more poles, stanchions or other supports erected near the vehicle path. One or more mounting brackets may then be used to attach the housing 42 to the poles or stanchion. Alternatively a planar surface such as a wall may used to receive the housing, depending upon the particular environment the system is to be deployed.

With the housing positioned in the desired location, the user then ensures that one or more sensors such as 28 are properly positioned so that when the vehicle actuates each sensor, the portion of the vehicle tire to receive the dressing is within the target zone of the respective spray head 40. In the preferred embodiment, each of the sensors 28 are positioned along the surface over which the vehicle tire rolls, thus ensuring positive contact between the tire and each sensor to provide the triggering signal to apply the dressing.

The invention has been described in an illustrative manner, and it is to be understood that the terminology that has been used is intended to be in the nature of description rather an of limitation. Many modifications and variations of the invention are possible in light of the foregoing description yet are intended to be considered to fall within the scope of the invention.

I claim:

1. An apparatus for applying a substance upon a predetermined surface area of a work piece at a specific instance in time, comprising:
at least one sensor disposed at a fixed location for detecting the presence of the work piece at said fixed location;
a spray assembly disposed proximate said fixed location for spraying a substance on the work piece when the work piece is at said fixed location; and
a processor assembly operably interconnected to said at least one sensor and to said spray assembly for causing said spray assembly to spray the substance upon the work piece upon receiving a signal from said at least one sensor.

2. An apparatus for applying a dressing to a predetermined surface area of a sidewall of a vehicle tire as it passes a fixed location along a fixed path of an automated car wash at a specific instant of time comprising:
at least one sensor disposed at a fixed location under or alongside said fixed path for detecting the presence of said vehicle tire at said fixed location;
a spray assembly disposed proximate said fixed location for spraying said dressing on said sidewall when it passes said fixed location; and
a processor assembly operably interconnected to said at least one sensor and to said spray assembly to spray said dressing upon said sidewall upon receiving a signal from said at least one sensor.

3. A method for applying a dressing upon a predetermined surface area of vehicle tire at a specific instant of time, comprising the steps of:
detecting the presence of said vehicle tire at a fixed location along the path traversed by said vehicle tire in an automated car wash; and
causing a spray assembly disposed proximate said fixed location to direct said dressing upon a predetermined area on said vehicle tire only during the step of detecting the presence of said vehicle tire.
